(19) United States
(12) Patent Application Publication
(10) Pub. No.: US 2014/0123282 A1
(43) Pub. Date: May 1, 2014

(54) UNPACKING FLASH EXPLOITS WITH AN ACTIONSCRIPT EMULATOR

(71) Applicant: FORTINET, INC., Sunnyvale, CA (US)

(72) Inventor: Bing Liu, North Vancouver (CA)

(73) Assignee: FORTINET, INC., Sunnyvale, CA (US)

(21) Appl. No.: 13/665,999

(22) Filed: Nov. 1, 2012

(51) Int. Cl. G06F 21/00

(52) U.S. Cl. 726/23

(57) ABSTRACT

Methods and systems for detecting an attempt to load embedded Flash are provided. According to one embodiment, an ActionScript emulator running on a computer system receives a Flash file to be tested. The ActionScript emulator implements a modified version of a class typically implemented by an ActionScript virtual machine. The ActionScript emulator reveals one or more tagged data blocks (tags) contained within the Flash file by decoding the Flash file. The ActionScript emulator determines whether the one or more tags are capable of containing ActionScript bytecode (ABC) by evaluating the one or more tags. When an affirmative determination results with respect to a tag of the one or more tags, then the ActionScript emulator interprets and executes the ABC associated with the tag. Responsive to invocation of a predetermined method of the modified class by the ABC, the ActionScript emulator reports existence of embedded Flash within the Flash file.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2012, Fortinet, Inc.

### BACKGROUND

1. Field

Embodiments of the present invention generally relate to the field of Flash files and players thereof. In particular, various embodiments relate to methods of scanning Flash files to detect techniques used for exploiting including heap and/or just-in-time compiler (JIT) spraying and to detect flash exploits by extracting and evaluating embedded Flash and/or embedded JavaScript.

2. Description of the Related Art

In today's communication world, data presentation to a user is one of the most important and creative tasks. Especially, online data presentation mechanisms are significantly and drastically changing based on user's needs and expectations. For instance, content can now be presented to a user in text, image, audio, video, and embedded formats, among many other formats or combinations thereof.

To represent these various types of formats, different programming techniques and file formats are being used. Flash format of Adobe is one such format, wherein Flash provides a multimedia platform that is used for adding animation, video, and interactivity to web pages. Flash is a tool for rich Internet applications and is used for advertisements, games and flash animation for broadcasting. Flash content can be displayed on various electronic devices and computer systems using Adobe Flash Player.

Flash provides animation of text, drawings, and still images, supports bidirectional streaming of audio and video, and captures user input via mouse, keyboard, microphone, and camera.

Flash development is based on an object-oriented language called ActionScript. ActionScript is basically a superset of the syntax and semantics of JavaScript language and is primarily used for the development of websites and software targeting the Adobe Flash Player platform. ActionScript 3.0 (hereinafter referred to as ActionScript) is introduced with Flash Player 9 embedded ActionScript Virtual Machine 2 (AVM2).

During execution of ActionScript code, the code is converted into ActionScript Byte Code (ABC) segments by a compiler and is stored in an ABC file with a DoABC tag or RawABC tag, and compiled into byte code, wherein DoABC and RawABC tags are container tags for ActionScript that are used for performing specific actions. The flash player calls the AVM2 to execute the ABC file.

Adobe Flash files are stored in ShockWave Flash (SWF) format, with a .swf extension for using multimedia, vector graphics and ActionScript. SWF is a widely used format for displaying “animated” vector graphics on the Web. It is also used for programs, commonly browser games, using ActionScript. It is also pertinent to note that with growing emphasis on development of computer software that handles user data, various threats including hacking, phishing, malware, and viruses are also now becoming common mechanisms for breach of security and access to crucial information. To handle these threats, various protection measures and systems are implemented to provide safety and security to users of the Internet. However, hackers, commonly called as attackers, tend to find alternatives to attack end user systems, for example.

Among various methods of hacking, use of exploits is a common method that attacker's use to attack users' computer systems. An exploit is a piece of software, a data chunk, or a sequence of commands, which take advantage of an error, fault, failure or vulnerability in a computer system, operating system, program or the like in order to cause unintended or unanticipated behavior to occur on a particular computer system. An exploit may result in denial of service or allow an attacker to access user data, perform arbitrary code execution or otherwise gain control of the computer system.

Exploiting techniques can typically be used by an attacker to cause an AVM to execute his/her exploiting techniques can be classified into various types, such as heap spraying and Just-In-Time (JIT) spraying, and may involve the use of embedded Flash, embedded JavaScript and the like. These exploiting techniques are explained below with respect to Adobe Flash player.

Heap spraying is an exploiting technique commonly used to allow an attacker to execute commands of the attacker's choice on a user's computer or in a user's process. In general, exploit source code attempts to put a certain sequence of bytes at a predetermined location in heap memory of a user process by allocating blocks on the user's process heap and filling bytes in these blocks with appropriate values.

A heap spray does not actually exploit any particular security issue, but instead makes various security issues easier to exploit. A heap spray can be used to introduce large amount of data, such as an address of a function the attacker desires to execute, into memory in order to increase the chances of successful exploitation. Heap sprays take advantage of the fact that on most architectures and operating systems, the start location of large heap allocations is predictable and consecutive allocations are roughly sequential. Therefore, the sprayed heap is roughly in the same location each and every time the heap spray is run. Heap spraying can be better explained with an example illustrated in the context of Flash files.

In general, program code, also referred to as a process hereinafter, is initially stored in a specified memory location of a user's computer and is executed whenever the user calls it. The compiler goes to the memory location, fetches the code and executes the code. In case of a Flash file, the compiler fetches ActionScript code, converts it to ABC segments and stores the resulting byte codes in ABC file with a DoABC tag and executes the code, but never interprets the code.

An attacker may create code that implements a heap spray and inject the code into a user process that allocates heap memory. The heap spray code can be used to spray the heap with specific bytes, typically representing an address of a function or procedure the attacker desires to be executed. Then, once a vulnerability is exploited, the application code can be made to read the address from the sprayed heap, thereby allowing the attacker to control subsequent flow of execution.

JIT spraying or Just-In-Time spraying is another type of exploit that impacts behavior of just-in-time compilation or dynamic compilation. JIT spraying bypasses two commonly used exploitation protection methods namely, Data Execution Prevention (DEP) and Address Space Layout Randomization (ASLR). JIT spraying is typically used to penetrate security features in PDF documents and Adobe's Flash technology. A JIT compiler produces code, which is stored in memory marked as executable. If the attacker's code is generated by the JIT engine, the exploit code will also reside in executable area. In other words, DEP or ASLR is not involved in protection of code emitted by the JIT compiler. The JIT spraying process basically compiles exploit code and proceeds to spray compiled code into the memory with enough instances of exploit code so as to overwhelm address space randomization and then execute the exploit itself.

A common JIT spraying technique is to fill user code with many XORs that are done with a constant, which ultimately result in an encoding of a desired instruction or set of instructions. Then, if the attacker can transfer the execution, by pointing the instruction pointer to the sprayed heap, the exploit payload can take control of the system. One mechanism for implementing heap or JIT spraying and/or gaining control of the instruction pointer is by way of embedded flash. Embedded flash may be used within a Flash file to trigger a flash vulnerability. A flash exploit or an attacker specified Flash file is embedded in a user/container file such as in a PDF file, Flash file, office document and the like. The container typically performs heap spraying as the exploiting technique and the flash exploit is used to gain control of the flow of execution.

Another mechanism for implementing heap or JIT spraying and/or gaining control of the instruction pointer is by way of embedded JavaScript within a container (e.g., an HTML page, a PDF file, Flash file, office document and the like). As above, the container may perform the heap spraying and a flash exploit implemented within the embedded JavaScript may be used to gain control of the flow of execution.

In view of Flash's ubiquity and the increasing use of ActionScript to implement heap and JIT spraying by attackers accompanied by Flash exploits embedded within Flash binaries, there is a need for methods and systems that can detect heap and/or JIT spraying and/or exploit code in embedded Flash and/or JavaScript.

### SUMMARY

Methods and systems are described for detecting an attempt to load embedded Flash. According to one embodiment, an ActionScript emulator running on a computer system receives a Flash file to be tested. The ActionScript emulator implements a modified version of a class typically implemented by an ActionScript virtual machine. The ActionScript emulator reveals one or more tagged data blocks (tags) contained within the Flash file by decoding the Flash file. The ActionScript emulator determines whether the one or more tags are capable of containing ActionScript bytecode (ABC) by evaluating the one or more tags. When an affirmative determination results with respect to a tag of the one or more tags, then the ActionScript emulator interprets and executes the ABC associated with the tag. Responsive to invocation of a predetermined method of the modified version of the class by the ABC, the ActionScript emulator reports existence of embedded Flash within the Flash file.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a high-level block diagram conceptually illustrating a system for detecting conditions indicative of heap spraying, JIT spraying, embedded Flash, embedded JavaScript and/or the existence of a known Flash exploit in Flash files in accordance with an embodiment of the present invention.

FIG. 2 illustrates exemplary functional units of ActionScript emulator in accordance with an embodiment of the present invention.

FIG. 3 illustrates typical format of a SWF file.

FIG. 4 is a flow diagram illustrating processing performed by a scanner in accordance with an embodiment of the present invention.

FIG. 5 is a flow diagram illustrating processing performed by ActionScript Emulator in accordance with an embodiment of the present invention.

FIG. 6 is a flow diagram illustrating processing performed by ActionScript Emulator during detection of exploiting techniques or occurrence of embedded Flash/JavaScript in accordance with an embodiment of the present invention.

FIG. 7 is an exemplary computer system in which or with which embodiments of the present invention may be utilized.

### DETAILED DESCRIPTION

Methods and systems are described for detecting an attempt to load embedded Flash. According to one embodiment, methods and systems are provided for detecting use of exploiting techniques including heap and/or JIT spraying in Flash files or other compatible file formats such as pdf, html, asp, and word document files for implementation of exploits. Systems are also provided for extracting and interpreting embedded flash and/or embedded JavaScript responsible for implementing such exploiting techniques in the Flash files or any other compatible file formats.

In one embodiment, an ActionScript emulator detects undesired heap and/or JIT spraying performed by code embedded within a Flash file. The ActionScript emulator may be further configured to extract embedded Flash files and/or embedded JavaScript.

According to one embodiment, a system for detecting conditions indicative of heap spraying, JIT spraying, embedded Flash, embedded JavaScript and/or the existence of a known Flash exploit in Flash files includes an input operatively connected with an ActionScript emulator through a scanner. The input can include a Flash file, a URL, a pdf file, or any other file format on which an exploiting technique such as heap and/or JIT spraying can be implemented. The input is provided to the scanner, which may be coupled in communication with a network, wherein the scanner is configured to retrieve content identified by the input and extract any associated Flash file(s). Extracted Flash files may first be processed by a rule matching engine to detect flash exploits that match known signatures stored in a rule file. The Flash file(s) may then be processed by an ActionScript emulator to detect conditions indicative of heap spraying, JIT spraying, an attempt to load embedded Flash, an attempt to evaluate embedded JavaScript and/or the existence of a known Flash exploits.

According to one embodiment, the system includes a scanner, a rule matching engine, and an ActionScript emulator. The scanner is operative to retrieve an HTML file associated with a URL identified by an input to the scanner. For each Flash file associated with the HTML file being processed, the scanner may first invoke the rule matching engine against the Flash file to see if the Flash file matches any known signatures. If not, the scanner may then invoke the ActionScript emulator on the Flash file. The ActionScript emulator reports to the scanner if it detects known exploit conditions, an occurrence of heap spraying or JIT spraying or the existence of embedded Flash or embedded JavaScript. In the case of embedded Flash or JavaScript, the ActionScript emulator may export the embedded code to the scanner. The scanner may recursively call the ActionScript emulator upon the identification of the existence of further embedded Flash. According to an embodiment, findings from the rule matching engine and/or the ActionScript emulator, including detected exploits, spray codes, embedded Flash files, or JavaScript, are presented as output to user on a display device.

According to one embodiment, the ActionScript emulator is configured to take a Flash file as an input from the scanner and detect conditions indicative of one or more of heap spraying, JIT spraying, an attempt to load embedded Flash, an attempt to evaluate embedded JavaScript and/or the existence of a known Flash exploit. The ActionScript emulator decodes the Flash file based on a SWF file format specification (e.g., Adobe Systems Incorporated, “SWF File Format Specification Version 9,” published June 2007), which is hereby incorporated by reference in its entirety for all purposes) so as to identify occurrence of tags (e.g., a DoABC tag or a RawABC tag) that are capable of containing ActionScript bytecode (ABC). When such tags are identified, the ActionScript emulator extracts the ABC (also referred to as an ABC file) associated with the identified tag and decodes the ABC file based on an ABC file format specification as described in Adobe Systems Incorporated, “ActionScript Virtual Machine 2 (AVM2) Overview,” published May 2007, which is hereby incorporated by reference in its entirety for all purposes. The retrieved ABC may then be executed within a controlled sandbox-like environment provided by the ActionScript emulator (which implements one or more modified classes of classes typically implemented by an ActionScript Virtual Machine (AVM) and one or more modified operators of operators typically implemented by an AVM). Detectors may be included within the modified operators and methods of the modified classes that identify the existence of one or more predetermined conditions associated with heap spraying, JIT spraying, an attempt to load embedded Flash and/or an attempt to evaluate embedded JavaScript by the ABC. Other detectors may be included within methods of the ActionScript emulator to identify the existence of one or more predetermined conditions associated with known exploits.

According to an embodiment, when an attempt to load embedded Flash or an attempt to evaluate embedded JavaScript is detected, the ActionScript emulator can be configured to export the embedded Flash or JavaScript to the scanner.

Embodiments of the present invention generally relate to systems and methods for scanning and emulating Flash files to detect conditions indicative of heap spraying, JIT spraying, attempts to load embedded Flash, attempts to evaluate embedded JavaScript and/or the existence of a known Flash exploit. Due to the vulnerabilities in Flash files during their execution, there is a need for methods and systems for scanning Flash files to identify and/or detect such potential vulnerabilities, including detection of conditions that are indicative of heap spraying or JIT spraying, which are exemplary mechanisms by which an attacker can attempt to cause execution of his/her desired exploit code. More particularly, heap spraying can be used as a technique for implementing exploits in Flash files or other compatible file formats, as once a certain sequence of bytes are put at a predetermined location in the memory by spraying a heap, an exploit code can be placed within the sprayed memory location. There is also a need for methods and systems for detecting an attempt to evaluate embedded JavaScript or to loading of an embedded Flash and extract the embedded Flash for further analysis. Embedded JavaScript can be used to exploit underlying client vulnerabilities. There is also a need to analyze detected conditions for spraying, extracted Flash, embedded JavaScript, or any other identified flash exploit for preventive and efficient execution of the code.

It will be appreciated by those skilled in the art that although the present disclosure is being made with reference to heap and JIT spraying as mechanisms for implementation of exploits, any other known or possible exploiting technique for allowing exploit code to be placed and executed across compatible file formats would be clearly included in the scope of the inventive subject matter. Similarly, although the present disclosure is being made with reference to embedded Flash files and embedded JavaScript, which can be involved in implementation of exploiting techniques, any other suitable set of instructions that can help implement a mechanism for creating an exploit is within the scope of the present disclosure. Multiple embodiments are described herein to scan Flash files and detect different conditions indicative of exploiting techniques and mechanisms for implementing such exploiting techniques.

Embodiments of the present invention also provide systems and methods for detecting presence of one or more exploiting techniques using conditions indicative of such techniques including heap spraying, JIT spraying, NOP slide, or Heap feng shui, or the like. Embodiments also provide methods and systems for detecting, extracting, and interpreting an embedded Flash and/or embedded JavaScript that may be responsible for implementation of the exploiting technique in Flash files or other compatible file formats. To be able to perform this functionality, the disclosure provides an ActionScript emulator that emulates the functionality of an AVM to provide a safe environment in which exploiting techniques and/or mechanisms such as embedded Flash that can be used to implement the exploiting technique can be detected and analyzed.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

Furthermore, the proposed system and method is configured to detect and report occurrence of exploiting techniques that are not only applicable to Flash files but also to all other compatible and appropriate file formats.

### TERMINOLOGY

Brief definitions of terms used throughout this application are given below.

The term “Flash player” generally refers to Flash player 9 software, or any other appropriate version of the Flash player, used for viewing multimedia, Rich Internet Applications and streaming video and audio, on a computer web browser or on supported mobile devices, wherein Flash player runs files with SWF extension.

The term “ActionScript” generally refers to ActionScript 3.0, or any other past, current of future version of ActionScript, which includes tags that can contain ABC.

The term “AVM2” generally refers to ActionScript Virtual Machine 2, which is a virtual machine that compiles and runs ActionScript that is targeted for Flash Player 9 and higher versions.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

The phrase “ActionScript emulator” generally refers to a system, which emulates an operating environment provided by an ActionScript Virtual Machine by implementing a subset of classes and associated methods and/or a subset of operators typically implemented by an ActionScript Virtual Machine. According to one embodiment, an ActionScript emulator, through or one or more “detectors” or code snippets, detects conditions indicative of heap spraying, JIT spraying, an attempt to load embedded Flash, an attempt to evaluate embedded JavaScript and/or the existence of a known Flash exploit resulting from exploit code injected into a Flash file by an attacker. As described further below, an ActionScript emulator may detect the conditions of interest by, among other things, decoding the SWF formatted Flash file to identify the presence of tags (e.g., DoABC and/or RawABC tags) that may contain ActionScript bytecode (ABC).

If the specification states a component or feature “may”, “can”, “could”, or “might” be included or have a characteristic, that particular component or feature is not required to be included or have the characteristic.

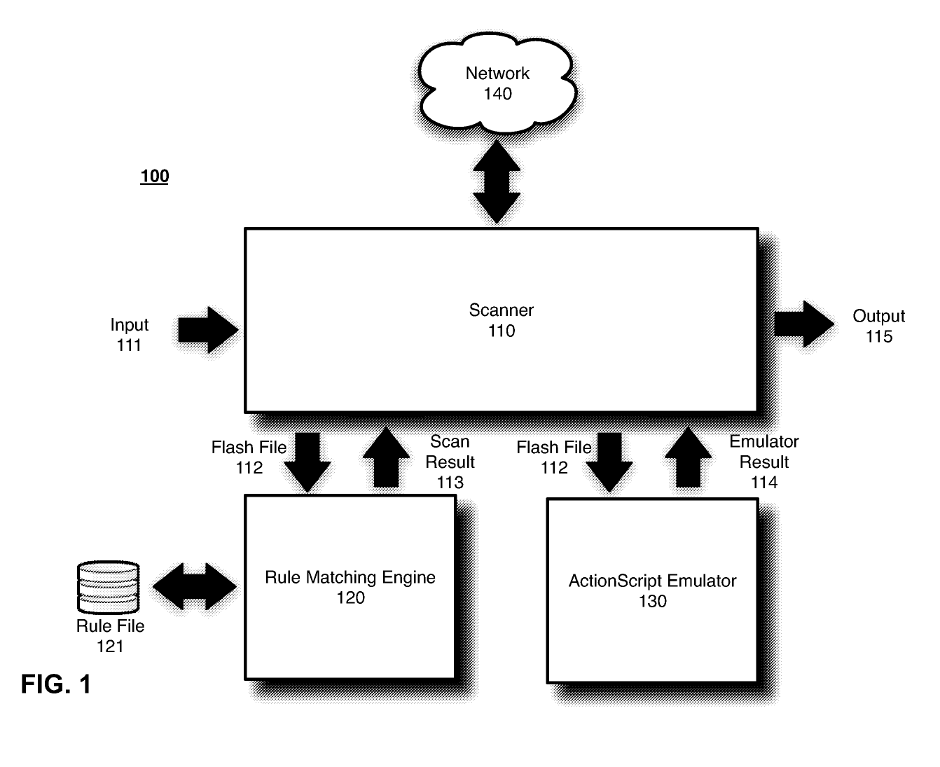

FIG. 1 is a high-level block diagram conceptually illustrating a system 100 for detecting conditions indicative of heap spraying, JIT spraying, embedded Flash, embedded JavaScript and/or the existence of a known Flash exploit in Flash files in accordance with an embodiment of the present invention.

According to one embodiment, system 100 includes an input 111 operatively connected with an ActionScript emulator 130 and/or a rule matching engine 120 through a scanner 110. Input 111 can include a Flash file, a URL, a pdf file, or any other file format on which an exploiting technique such as heap and/or JIT spraying can be implemented. Input 111 is provided to scanner 110, which may be coupled in communication with a network, wherein scanner 110 retrieves content identified by input 111 and extracts any associated Flash file(s) 112. Multiple inputs 111 may also be given to scanner 110 at the same time for parallel processing and extraction of multiple Flash files 112. For instance, scanner 110 can receive a Uniform Resource Locator (URL) to be tested for any potential vulnerability or exploit, based on which scanner 110 issues HyperText Transport Protocol (HTTP) request for the URL. In response to the HTTP request, scanner 110 receives HyperText Markup Language (HTML) file and scans the HTML file to detect and extract one or more Flash files that are embedded in the HTML file. Once Flash files 112 are extracted, scanner 110, using ActionScript emulator 130 and/or rule matching engine 120, detects conditions indicative of heap spraying, JIT spraying, embedded Flash, embedded JavaScript and/or the existence of a known Flash exploit in Flash files 112.

When one or more associated Flash files 112 are extracted, the extracted Flash files 112 may be sent to rule matching engine 120 to detect flash exploits that match known signatures stored in a rule file 121. According to one embodiment, rule matching engine 120 is operatively coupled to scanner 110 and can either be implemented on the same computing device as the scanner or on a remote device, which is connected to scanner 110 over a network. Rule matching engine 120 takes Flash file(s) 112 as input and matches each Flash file 112 with known or predefined set of signatures stored in rule file 121. As numerous flash exploits are already well known, signatures for known flash exploits can be created such that the flash exploits can be detected without decoding the Flash files 112 simply by matching input Flash files 112 with signatures. Using rule matching engine 120 helps efficiently detect existence of known Flash exploits in Flash files 112.

Rule file 121 can be operatively coupled with rule matching engine 120 and can be stored on a separate database, wherein rule file 121 stores specific signatures such as CVE-2012-0779, CVE-2012-1535, among others that relate to known exploits. As these exploits are already known, their impact, behavior, and manner of implementation is already known and therefore can be detected quickly. In case Flash files 112 match with any of the signatures, the findings can be reported as a scan result 113 to scanner 110. The scanner 110 can then either choose to send the Flash files 112 to the ActionScript emulator 130 or present scan result 113 to output 115. Flash files 112 that are given as input to rule matching engine 120 can also include embedded Flash files, which are embedded within Flash files 112 extracted by scanner 110. In case the Flash files 112 do not match with any known signature, scanner 110 may invoke ActionScript emulator 130 on the Flash files 112.

ActionScript emulator 130 receives Flash file 112 from scanner 110 and is configured to report to scanner 110 if it detects known exploit conditions, an occurrence of heap spraying or JIT spraying, or existence of embedded Flash or embedded JavaScript. ActionScript emulator 130 can be configured to implement one or more modified classes of classes typically implemented by an ActionScript Virtual Machine (AVM) and one or more modified operators of operators typically implemented by an AVM. ActionScript emulator 130 therefore emulates the functionality of an AVM to provide a safe environment in which conditions indicative of heap spraying, JIT spraying, embedded Flash, embedded JavaScript and/or the existence of a known Flash exploit in Flash files, can be detected.

In order to detect the presence of exploiting techniques or embedded codes/files in a received Flash file 112, ActionScript emulator 130 typically decodes Flash file 112 based on an appropriate SWF file format specification so as to identify occurrence of tags (e.g., a DoABC tag or a RawABC tag) capable of containing ActionScript bytecode (ABC). ActionScript emulator 130 therefore decodes Flash file 112 to reveal one or more tagged data blocks, also referred to as tags hereinafter, that are contained within Flash file 112. The identified tags are then analyzed to determine whether they (such as DoABC tag or RawABC tag) are capable of containing ActionScript bytecode (ABC). When such tags are identified, the ActionScript emulator extracts the ABC (also referred to as an ABC file) associated with the identified tag and decodes the ABC file based on the ABC file format specification to interpret and execute the same.

ActionScript emulator 130 can incorporate one or more detectors within the modified operators and modified methods of classes. The detectors can be used to implement one or more predetermined conditions that are configured to identify existence of associated with exploiting techniques such as heap spraying, JIT spraying or associated with an attempt to load embedded Flash and/or an attempt to evaluate embedded JavaScript by the ABC. Detectors can also be included within methods of the ActionScript emulator 130 to identify existence of one or more predetermined conditions associated with known exploits. Once exploiting techniques such as heap spraying are detected, exploit codes which use these techniques can also be extracted, analyzed, and reporting for corrective action.

According to one embodiment, one or more detectors may be used for detecting heap spraying by incorporating conditions indicative of heap spraying. Detectors can be implemented within ActionScript emulator 130, wherein ActionScript emulator 130 emulates the functionality of an AVM to provide a safe environment in which heap spraying can be detected. To detect heap spraying, one or more detectors may be placed in a “push” method of modified class “Array” of the ActionScript emulator 130, and configured to detect heap spraying when same large size content is pushed to the same array multiple times. Table A shows exemplary code that performs heap spraying in a Flash file. Attacker, in the present example, has injected following exploit code in a portion of ActionScript to be executed and uses Heap Spraying as an exploiting technique:

TABLE A

public static function alloc_event(arg0:TimerEvent):void

{

var loc0:* = new ByteArray( );
loc0.writeBytes(pool);
allocs.push(loc0);
return;

}

public static function alloc(arg0:*, arg1:int):void

{

if(null == allocs)

{

allocs = new Array( );

}

dstSize = arg1;
remainder = 0;
init_pool(arg0);
var loc0:* = new Timer(2, dstSize /POOL_SIZE);
loc0.addEventListener(TimerEvent.TIMER,

alloc_event);

loc0.start( );
return;

}

In the above ActionScript code example, exploit code is injected in a specified location of a Flash file (e.g., Flash file 112). When the Flash file 112 is compiled and converted into ActionScript ByteCode and executed, injected exploit code is also compiled and executed along with script code of Flash file 112. In the execution, a pointer of the AVM2 starts executing the code line by line, moves to a memory location to which the code points, and fetches data present in the code specified memory location. During execution, the pointer of AVM2 may reach exploit code injected by an attacker and may continue executing the code without knowing that the code is exploit code. This opens systems that support Flash files to vulnerability

In order to detect exploiting techniques, such as heap spraying discussed above, ActionScript emulator 130 first receives Flash file 112 to be evaluated and then decodes Flash file 112 to scan multiple tags and identify tags (such as DoABC and RawABC tags) that are capable of storing ABC. Once ABC has been retrieved, ActionScript emulator 130, which emulates the functionality of AVM, incorporates one or more detectors in the “push” method of modified class “Array” within ActionScript emulator 130. ActionScript emulator 130 implements the modified class “Array” of a class that is typically implemented by ActionScript virtual machine. During emulation, ActionScript emulator 130, detects the presence of heap spraying responsive to predetermined conditions implemented by one or more detectors implemented within the “push” method of class “Array”. One such condition implemented by the detector(s) can include assessment of whether the same large size content is being pushed (using “push” method) into the same array (of class “Array”) multiple times. When the detector identifies that the count of pushing the same large content into same array multiple times is beyond a predefined threshold, for example, ActionScript emulator 130 detects and confirms heap spraying and reports the findings to scanner 110 as Emulator Result 114.

Table B shows a code snippet illustrating detectors and conditions implemented thereby that may be used in ActionScript emulator 130 for detecting conditions indicative of heap spraying by implementing a detector within the push method of class Array. In the example illustrated below, based on size of data being pushed into an array, the detector reports heap spraying activity based on a predefined or configurable threshold. In the present example, the detector is implemented to check whether the total size of data that is being pushed into an array is greater than 1000 bytes, and whether the data is being pushed in same array more than a predetermined or configurable number (i.e., HSThrehsold1) of times. When both conditions are met then the existence of heap spraying is reported to scanner 110.

TABLE B

Method Toplevel_Array_Push(data)

{

If(sizeof(data)) > 1000)

{

Md5=MD5Sum(data);
HS[Md5]++;
If(HS[Md5]==HSThreshold1)//only report

once

{

MarkHeapSpraying( );
SaveHSContent(Md5,data);

}

}

}

It will be appreciated by those skilled in the art that the initial process of receiving Flash file 112 and identifying tags capable of containing ABC is common to many of the other methods described herein that are configured to detect the presence of exploiting techniques or presence of embedded Flash or embedded JavaScript as the ActionScript emulator 130 is configured to interpret and execute ABC through the modified classes of classes that are typically implemented by AVM. A description of these steps therefore is not repeated below for detection of other exploiting techniques.

Also, as described above, scanner 110 is configured to receive input 111, such as a URL, that is to be tested for presence/implementation of a potential exploiting technique. Scanner 110 can then issue a HyperText Transport Protocol (HTTP) request for the URL and then receive an HTML file as the response to the request. Scanner 110 can then be configured to scan the received HTML file and extract Flash file(s) 112 that are embedded in the HTML file. Scanner 110 can then choose to either send the extracted Flash file 112 to rule matching engine 120 for matching with known signatures stored in rule file 121 and then if match is found, send the Flash file 112 to ActionScript emulator 130, or can send the extracted Flash file 112 directly to ActionScript emulator 130 to detect conditions indicative of heap spraying, JIT spraying, an attempt to load embedded Flash, an attempt to evaluate embedded JavaScript and/or the existence of a known Flash exploit. As these steps of extraction of Flash file 112 by scanner 110 and processing of Flash file 112 at either rule matching engine 120 or ActionScript emulator 130 or both, are common across detection of various exploiting techniques and methods for detecting exploit codes, these details are not repeated below in connection with the description of detection mechanisms for other exploiting techniques, flash exploits, or embedded Flash, or embedded JavaScript.

According to one embodiment, ActionScript emulator 130 can be configured to detect different possible types of exploiting techniques including detecting multiple mechanisms for conducting heap spraying by defining and using appropriate detectors in the ActionScript emulator 130. Another exemplary type of heap spraying technique uses undocumented instructions such as si8, si16, si32, and the like for allocating memory, wherein these instructions have a format of si#n and are injected in the ActionScript code of Flash file 112 and are configured to assign #n bits of memory in global memory upon execution. For instance, Table C illustrates use of si#n instructions as a heap spraying exploiting technique to implement an exploit in Flash file 112.

TABLE C

method <q>[public]::void
<q>[public]::populateHeap=(<q>[public]::int,
<q>[public]::Array, <q>[public]::int, <q>[public]::Array,
<q>[public]::Array)(5 params, 0 optional)
[stack:4 locals:11 scope:1-2 flags:] slot:0
{
...
00047) + 0:1 jump −>64
00048) + 0:1 label-------copy first array content (second
input parameter)
...
00056) + 0:1 getlocal r8------------------value
00057) + 1:1 getlocal r6------------------offset
00058) + 2:1 si32-------------------------write the value
at offset in the global memory
...
00066) + 2:1 getproperty <q>[public]::length----array
length
00067) + 2:1 convert_i
00068) + 2:1 iflt −>48
...
00090) + 0:1 jump −>107
00091) + 0:1 label-------copy second array content (fourth
input parameter)
...
00101) + 2:1 si32--------write the value at offset in the
global memory
...
00111) + 2:1 iflt −>91
...
00118) + 0:1 jump −>133
00119) + 0:1 label-------copy third array content (fifth
input parameter)
...
00127) + 0:1 getlocal r8
00128) + 1:1 pushbyte 66------------decoding key
00129) + 2:1 bitxor
00130) + 1:1 getlocal r6
00131) + 2:1 si8-------------------write the value at
offset in the global memory
...
}

In the exemplary code snippet shown above in Table C, an attacker has injected method populateHeap, which includes three arrays and five parameters. The first parameter is for spray size of the first array and the third parameter is for the number of times the second array is copied. In the context of heap spraying, the populateHeap method may be called repetitively causing heap of memory to be allocated in global memory.

In one embodiment, in order to detect heap spraying, one or more detectors are implemented within ActionScript emulator 130 to test conditions indicative of the use of instructions such as si8/si16/si32 and the like. When the ActionScript emulator 130 emulates the code at issue, detectors implemented in ActionScript emulator 130 check whether each time an instruction of type si#n is executed, if the accumulated memory size allocated by instructions si#n is above a predefined or configurable threshold. If the accumulated memory allocated by instructions si#n is beyond the threshold, ActionScript emulator 130 confirms the existence of heap spraying functionality within Flash file 112 and reports the findings, as emulator result 114, to scanner 110.

The following code snippet shown in Table D illustrates an exemplary implementation of detectors within an AS_si8 method of ActionScript emulator 130, wherein the condition implemented in the detectors checks for whether the global memory size is greater than HSThreshold2. Once this condition is met during execution, the ActionScript emulator 130 confirms detection of heap spraying and reports the findings to scanner 110.

TABLE D

//Detect Heap Spraying
Method AS_si8(method,pc)

{

Globalmemory.store(getvalue(pc),1);
If(Globalmemory.size( )> HSThreshold2)

{

Md5=MD5Sum(Globalmemory);
MarkHeapSpraying( );
SaveHSContent(Md5,Globalmemory);

}

}

Method AS_si16(method,pc)

{

Globalmemory.store(getvalue(pc),2);
If(Globalmemory.size( )> HSThreshold2)

{

Md5=MD5Sum(Globalmemory);
MarkHeapSpraying( );
SaveHSContent(Md5,Globalmemory);

}

}

Method AS_si32(method,pc)

{

Globalmemory.store(getvalue(pc),4);
If(Globalmemory.size( )> HSThreshold2)

{

Md5=MD5Sum(Globalmemory);
MarkHeapSpraying( );
SaveHSContent(Md5,Globalmemory);

}

}

According to one embodiment, ActionScript emulator 130 is configured to detect JIT spraying, which is another exploiting technique through which an attacker can attempt to cause the AVM to execute his/her desired exploit code. As illustrated below, a typical JIT spraying technique involves the use of XOR instructions in which XOR operators can be processed with constant values to cause JIT spraying. Upon injecting XOR operators in ActionScript with some constant, the constant value can be XORed with the instruction to which it is injected and memory address pointed by the instruction changes with respect to XORed constant value and a new memory address is generated and stored for the XORed instruction.

Table E illustrates sample ActionScript that corresponds to an exploit code that uses a JIT spraying mechanism.

TABLE E

method * <q>[packageinternal]::funcXOR1=( )(0 params, 0
optional)
[stack:2 locals:2 scope:8-8 flags:] slot:l

{

00000) + 0:0 pushint 1016107152
00001) + 1:0 pushint 1016107152
00002) + 2:0 bitxor
00003) + 1:0 pushint 1016107152
00004) + 2:0 bitxor
00005) + 1:0 pushint 1016107152
00006) + 2:0 bitxor
00007) + 1:0 pushint 1016107152
00008) + 2:0 bitxor
00009) + 1:0 pushint 1016107152
00010) + 2:0 bitxor
00011) + 1:0 pushint 1016107152
00012) + 2:0 bitxor
...
00647) + 1:0 pushint 301989888
00648) + 2:0 bitxor
00649) + 1:0 pushint 892679477
00650) + 2:0 bitxor
00651) + 1:0 coerce_a
00652) + 1:0 setlocal r1
00653) + 0:0 getlocal r1
00654) + 1:0 returnvalue

}

ActionScript code such as that illustrated above may be contained within a Flash file, such as Flash file 112. As such, when the Flash file is processed the exploit code is executed along with other legitimate ActionScript code associated with Flash file 112, thereby causing and/or exploiting vulnerabilities. The Injected exploit code, as shown above, uses JIT spraying technique by implementing successive pushint and bitxor operations, wherein the pushint pushes random numbers and XOR's them with specific memory locations so as to generate a new address and execute the undesired data present in the newly generated address. Vulnerability is created in the system by repeated execution of the exploit code as the executor continuously outputs content from newly generated XORed addresses.

According to one embodiment, ActionScript emulator 130 can be configured to detect JIT spraying functionality implemented within a Flash file, such as Flash file 112. For example, ActionScript emulator 130 may implement one or more detectors in the bitxor instructions. Then, as ActionScript emulator 130 emulates the functionality of the AVM and executes the ABC, the detectors detect JIT spraying in Flash file 112 based on conditions set forth in the detectors. An exemplary condition can include computation of the number of successive pushint and bitxor operations, wherein when number of such successive operations is above a predefined or configurable threshold, JIT spraying is detected and reported by ActionScript emulator 130 to scanner 110. The following exemplary code snippet of Table F can define a detector to be implemented within method AS bitxor of modified classes of ActionScript emulator 130 and configured to be used to detect potential JIT spraying based on whether the number of successive bitxor operations being higher than a defined threshold. If the number of operations is greater than defined threshold, JIT spraying can be detected by ActionScript emulator 130 and reported to output 115 as Emulator Result 114.

TABLE F

//detect JIT Spraying
Method AS_bitxor(method,pc)
{

If(jit−>successivePushandXor(pc))
{

If(jit−>length) == JITthreshold)//only report

once

{

MarkJITSpraying( );
SaveJITContent(jit);

}

}
Else resetjit(jit);
V1=getvalue(pc);
V2=getvalue(pc);
Stack_push(v1\hat{ }v2);

}

In an embodiment, once ActionScript emulator 130 has detected that a JIT spraying technique has been used, the emulator 130 can be configured to analyze the relevant code snippet and report findings including number of bitxor operations, location of bitxor operation, number of occurrences in the ActionScript code, portion of ActionScript code having the exploit code, or other relevant information to scanner 110 as Emulator Result 114.

According to one embodiment, in addition to detecting exploiting techniques such as heap and/or JIT spraying, ActionScript emulator 130 is configured to detect occurrences of embedded Flash and/or embedded JavaScript that may exploit a particular vulnerability. It will be appreciated by those skilled in the art that embedded Flash and embedded JavaScript are only two exemplary means for implementing exploiting techniques such as heap spraying and JIT spraying and such exploiting techniques can use many other compatible means for implementation of exploits in Flash files or compatible file formats.

In one embodiment, ActionScript emulator 130 is configured to detect occurrences of embedded Flash or detect an attempt to load embedded Flash. As embedded flash is a common mode of implementing exploiting techniques, detecting an attempt to load flash can help in extracting and evaluating the embedded Flash. Embedded Flash files can typically be incorporated in multiple file formats such as .html, .doc, .pdf, .swf, or other such file formats causing vulnerabilities in such formats if exploits are placed in the embedded files. Table G illustrates exemplary code that loads embedded Flash:

TABLE G

internal function frame1( )
{
...
this.r = this.hexToBin(this.t);
this.ldr = new Loader( );
loadBytes(this.r);
stop( );
return;
}

The above exemplary code snippet illustrates loading of embedded Flash by the method loadBytes of class Loader. Typically, embedded Flash is injected at a specified location of Flash file 112, wherein when Flash file 112 is compiled and converted to ActionScript ByteCode and executed, the embedded Flash is also compiled and executed. As a result, if left undetected, embedded Flash may be loaded into memory. This loading of bytes in memory can lead to execution of undesired code during execution of the ActionScript code.

According to one embodiment, one or more detectors can be included within the loadBytes method of a modified Loader class implemented by ActionScript emulator 130 to identify meeting of one or more predetermined or configurable conditions associated with an attempt to load embedded Flash. Once such an attempt is detected and predetermined conditions are met, the embedded Flash can be extracted and reported back to scanner 110 for analysis and/or reporting to end user. To identify embedded Flash, such as that illustrated above, a detector having a defined condition may be added to method loadBytes of a modified class Loader (an unmodified version of which would typically be implemented by an AVM), wherein ActionScript emulator 130 reports existence of embedded Flash within Flash file 112 in response to invocation of the method loadBytes and meeting of the condition imposed by the detector. The identified embedded Flash may be extracted and exported to scanner 110 as part of Emulator Result 114 for possible further analysis by Flash Scanner 120. The following exemplary code snippet of Table H can be used to detect loading of embedded Flash and extract the same. As can be seen, detectors have been positioned in method loadBytes of modified class Loader of ActionScript emulator 130 that calculate an MD5 checksum of the Flash attempted to be loaded and may report back to scanner 110, both the checksum as well as the Flash.

TABLE H

//Extract embedded Flash
Method Flash_display_ Loader_loadBytes(bytes)
{

Md5=MD5Sum(bytes−>data);
MarkEmbedFlash( );
SaveFlash(Md5,bytes−>data);

}

According to one embodiment, ActionScript emulator 130 is also configured to detect the existence of embedded JavaScript. The following exemplary ActionScript code of Table I illustrates an attempt to use a method associated with the container (e.g., an HTML page) to execute embedded JavaScript:

TABLE I

method <q>[public]::void
<q>[public]::injectHTML=(<q>[public]::String)(1 params,
0optional)
[stack:4 locals:6 scope:1-1 flags:] slot:0
{
00000) + 0:0 pushbyte 0
00001) + 1:0 setlocal r5
00002) + 0:0 pushstring “”
00003) + 1:0 coerce <q>[public]::String
00004) + 1:0 setlocal_2
00005) + 0:0 pushbyte 0
00006) + 1:0 convert_i
00007) + 1:0 setlocal_3
00008) + 0:0 getlocal_1
00009) + 1:0 getproperty <q>[public]::length
00010) + 1:0 convert_i
00011) + 1:0 setlocal r4
00012) + 0:0 jump −>34
00013) + 0:0 label
00014) + 0:0 getlocal_3
00015) + 1:0 inclocal_i r3
00016) + 1:0 convert_i
00017) + 1:0 setlocal r5
00018) + 0:0 getlocal_2
00019) + 1:0 pushstring “%”
00020) + 2:0 add
00021) + 1:0 coerce <q>[public]::String
00022) + 1:0 getlex <q>[public]::StringTools
00023) + 2:0 getlocal_1
00024) + 3:0 getlocal r5
00025) + 4:0 callproperty <q>[public]::charCodeAt, 1 params
00026) + 3:0 coerce_a
00027) + 3:0 pushbyte 2
00028) + 4:0 callproperty <q>[public]::hex, 2 params
00029) + 2:0 coerce <q>[public]::String
00030) + 2:0 add
00031) + 1:0 coerce <q>[public]::String
00032) + 1:0 coerce <q>[public]::String
00033) + 1:0 setlocal_2
00034) + 0:0 getlocal_3
00035) + 1:0 getlocal r4
00036) + 2:0 iflt −>13
00037) + 0:0 getlex
<q>[public]flash.external::ExternalInterface
00038) + 1:0 pushstring “eval”
00039) + 2:0 pushstring
“document.getElementById(‘wank’).innerHTML = unescape(’”
00040) + 3:0 getlocal_2
00041) + 4:0 add
00042) + 3:0 coerce <q>[public]::String
00043) + 3:0 pushstring “‘)”
00044) + 4:0 add
00045) + 3:0 coerce <q>[public]::String
00046) + 3:0 callpropvoid <q>[public]::call, 2 params
00047) + 0:0 returnvoid
}

The above exemplary code snippet includes embedded JavaScript by means of invoking a method “call” of class ExternalInterface with an eval parameter.

Such embedded JavaScript may be detected by ActionScript emulator 130 implementing a “call” method within a modified class ExternalInterface. In this manner, a detector within the call method can determine whether the “eval” parameter has been used in the “call” method. As flash usually uses the “eval” parameter (in the format of ExternalInterface.call(eval(StringfromCharCode(102, 117 . . . )))) to execute embedded JavaScript, use of a detector in the call method in the ExternalInterface.Function class can be used to intercept and extract the embedded JavaScript, which can then be reported to scanner 110 as Emulator Result 114.

In order to extract embedded JavaScript from Flash file 112, ActionScript emulator 130 is first configured to implement modified classes of a class (such as ExternalInterface) that is typically implemented by an AVM or by a container (such as an HTML page). The modified class ExternalInterface can include a call method, in which one or more detectors having predetermined conditions can be implemented by ActionScript emulator 130. During emulation, ActionScript emulator 130 decodes Flash file tags that may contain ABC by evaluating one or more tags. Once tags containing ABC have been obtained, ActionScript emulator 130 is then configured to detect presence of embedded JavaScript when the method call is invoked and predetermined conditions implemented in one or more detectors are met (e.g., presence of the “eval” parameter). Detected embedded JavaScript can then be extracted and reported to scanner 110 as emulator result 114. The following exemplary code snippet of Table J may be used to detect an occurrence of embedded JavaScript based on meeting of conditions implemented in one or more detectors. As can be observed in Table J, a detector has been implemented in the call method (Flash_External_ExternalInterface_call) through a condition “If (!strcmp(name,“eval”))”, which if met confirms existence of embedded JavaScript. As above, in the context of embedded Flash, the detector may be configured to calculate an MD5 checksum of the JavaScript attempted to be evaluated and may report back to scanner 110, both the checksum as well as the JavaScript.

TABLE J

Method Flash_External( )
{

Flash_External_ ExternalInterface( );

}
//Extract embedded JavaScript
Method Flash_External_{—}
ExternalInterface_call(name,...args)

{

If (!strcmp(name,”eval”))

{

Md5=MD5Sum(args);
MarkEmbedJavaScript( );
SaveJavaScript(MD5,args);

}

}

According to one embodiment, ActionScript emulator 130 is used to detect an attacker injected exploit code present in a Flash file 112 through one or more detectors incorporated in the code of ActionScript emulator 130, wherein the detectors can be positioned in classes, methods, objects, namespaces, or other code that form part of the sandbox environment created by ActionScript emulator 130 to detect an exploit during evaluation of Flash file 112. If the detector identifies changes in modified classes or modified namespaces that are executed with respect to classes or namespaces that are stored, ActionScript emulator 130 identifies the existence of a known exploit in Flash file 112. For instance, consider that a class RadioButtonGroup and a namespace fl.controls are declared in a Flash file code of a user to be executed, wherein the ActionScript code is stored in a memory location or a register. Flash compiler can be configured to compile the ActionScript and execute every instruction of the code by pointing to every instruction that is stored in the register and perform the specific function. Exploit code, as described above, can change one byte address of an instruction in the register and when the ActionScript code (having exploit code) is executed, the compiler would be unaware of change in one byte address value, taking the execution pointer to a new address, wherein the new address generated by the change in one byte of address now points to a new class, say Button. For example, the code actually intended to be executed is as follows:

sealed protectedNS([protected]fl.controls:RadioButtonGroup)
class <q>[public] fl.controls::RadioButtonGroup extends
<q>[public]flash.events::EventDispatcher{

However, the code that is executed after changing one byte of address is as follows:

sealed protectedNS([protected]fl.controls:RadioButtonGroup)
class <q>[public] fl.controls::Button extends
<q>[public]flash.events::EventDispatcher{

In the above exploit code, protected namespace field of a class of the classes having a first predetermined value of “fl.controls::RadioButtonGroup” is replaced by a class name of the class having a second predetermined value “fl.control::Button”, thereby creating a known exploit commonly known as the CVE-2010-3654 vulnerability, which can cause a crash and potentially allow an attacker to take control of the affected system.

According to one embodiment, ActionScript emulator 130 can be configured to detect and interpret exploit code in Flash file 112 during its emulation and report its findings to scanner 110 through Emulator Result 114. ActionScript emulator 130 may be configured to report existence of a known Flash exploit within Flash file 112 using a method implemented by ActionScript emulator 130 to detect or observe the existence of one or more predetermined or configurable conditions. For example, the existence of certain values within particular protected namespace fields and/or the presence of a particular class within a Flash file may reveal the existence of a known Flash exploit. Flash file 112 is first received by ActionScript emulator 130 and detectors implemented in the code of ActionScript emulator 130 then report existence of a known Flash exploit within Flash file 112 based on one or more predetermined conditions implemented in the detectors being met. In one embodiment, ActionScript emulator 130 is configured to parse the classes of Flash file 112 and verify whether a protected namespace field of a class of the classes has a first predetermined value (e.g., fl.controls::RadioButtonGroup) and whether the class name of the class has a second predetermined value (e.g., fl.control::Button). Such conditions are indicative of a known Flash exploit commonly referred to as CVE-2010-3654.

In the above-described example involving RadioButton group, ActionScript emulator 130 is configured with a detector positioned within its code to check an exploit based on evaluation of whether properties of the RadioButtonGroup class remain same or change when compared to other classes such as that of Button. In present example, a detector present in ActionScript emulator 130 code can identify an irregularity in class name as the class name “Button” present in the exploit code is different from the called and desired class name “RadioButtonGroup.Detector”. Once detected, this finding can be reported by ActionScript emulator 130 to scanner 110 to be sent to output 115. The following exemplary code snippet in Table K can be used for detecting such exploit code, wherein detectors are configured to implement a condition to check whether protected namespace field of a class of the classes has a value of “fl.controls::RadioButtonGroup” and whether class name of the class has a value of “fl.control::Button”, in which case the code is marked as an exploit.

TABLE K

Method ParseClasses( )
{

ForEach(Classes)
{

If(class−>protectedNS is

“fl.controls::RadioButtonGroup”) &&

class−>classname is “fl.control::Button”)
{

MarkExploit(“CVE-2010-3654”);

}

}

}

It will be appreciated by those of skill in the art that using the ActionScript emulator 130 of the present disclosure and one or more detectors incorporated therein, various other types of exploits affecting Flash files or other compatible file formats can be detected and reported.

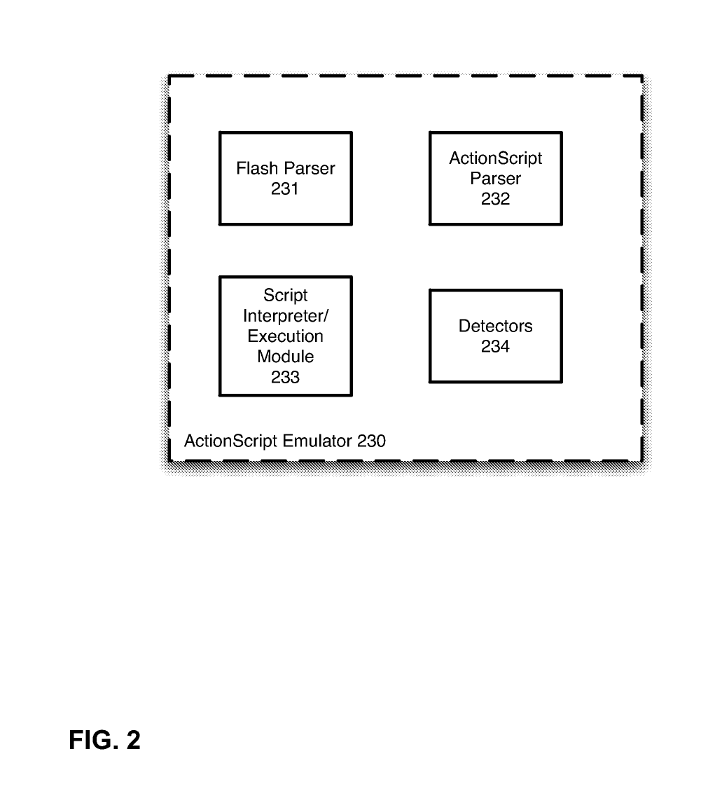

FIG. 2 illustrates exemplary functional units of an ActionScript emulator 230. ActionScript emulator 230 is configured to detect conditions indicative of heap spraying, JIT spraying, an attempt to load embedded Flash, an attempt to evaluate embedded JavaScript and/or the existence of a known Flash exploit. ActionScript emulator 230 is further configured to extract embedded Flash or relevant portion of the code that implements exploiting techniques and report the findings and/or files to scanner 110. As discussed earlier, exploiting techniques may include, but are not limited to, heap spraying and JIT spraying, and can be used to create exploits in Flash or other compatible file formats.

ActionScript emulator 230 includes a flash parser 231, an ActionScript Parser 232, a Script interpreter/execution module 233, and one or more detectors, collectively referred to as detectors 234 hereinafter. Flash parser 231 receives Flash file 112 as an input and decodes Flash file 112 based on a SWF file format specification to identify occurrence of tags that can contain bytecode (e.g., the DoABC (82) tags and/or the RawABC (72) tags of version 9 of the SWF File Format Specification). Flash parser 231 further extracts the ABC data, which is a block of ActionScript bytecode intended to be parsed by the ActionScript virtual machine, (at times referred to herein as “the ABC file”) stored in the identified DoABC and/or RawABC tags and decodes the ABC file based on ABC file format specification to retrieve the embedded ActionScript from the Flash file 112.

ActionScript Parser 231 parses ActionScript code that is decoded by flash parser 231. In one implementation, ActionScript Parser 232 parses syntax of the code line by line or in functional/structural blocks so as to extract the flow of execution and identify intended calls to methods of typical AVM-implemented classes or calls to methods of a container (e.g., an HTML page) of the Flash file 112.

Script interpreter/execution module 233 of the ActionScript emulator 230 executes parsed ActionScript code and simultaneously interprets the code to detect one or more exploiting techniques or occurrence of embedded JavaScript or embedded Flash. For example, script interpreter/execution module 233 runs within a sandbox-type environment created by ActionScript emulator 230 by calling upon one or more modified classes of classes, or one or more modified operators of operators, typically implemented by an ActionScript Virtual Machine (AVM) and by positioning detectors 234 within ActionScript emulator 230. Detectors may be included within the modified operators or methods of the modified classes so as to identify existence of one or more predetermined conditions associated with heap spraying, JIT spraying, an attempt to load embedded Flash and/or an attempt to evaluate embedded JavaScript by the ABC. Module 233 then interprets execution of ActionScript code to determine behaviour of the code corresponding to detectors 234 and reports any detection of an exploiting technique or occurrence of an embedded Flash/JavaScript that may be used for implementation of the exploiting technique. Module 233 can also extract embedded Flash files and/or embedded JavaScripts, if any, from Flash file 112 so that the embedded code can be scanned and analyzed for a potential implementation of exploit.

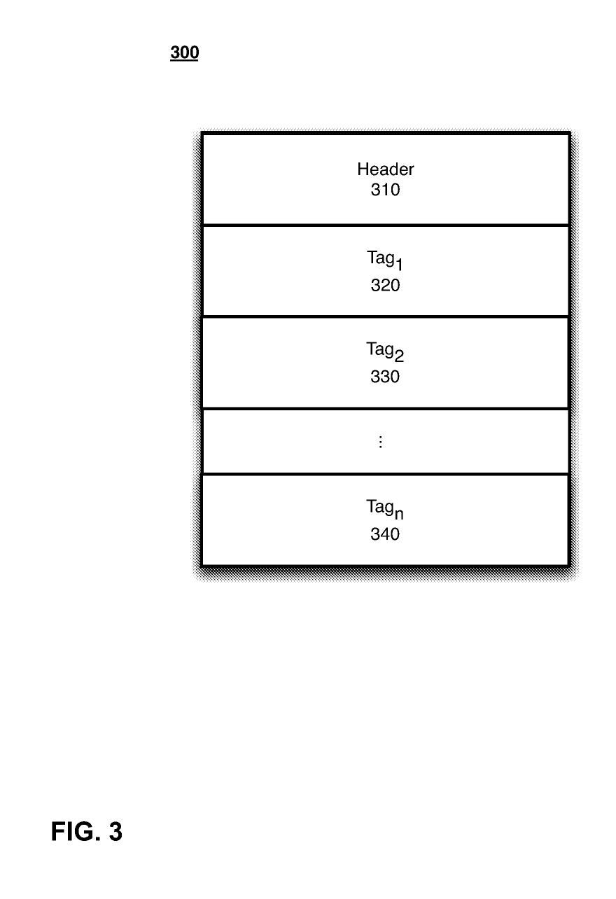

FIG. 3 illustrates typical format 300 of a SWF file 112. Flash file, commonly also referred to as SWF (Small Web Format) file 112, typically comprises of a header 310 and a series of tags 320, 330, . . . , 340, where the tags represent block of data. Header 310 includes information describing attributes of SWF file 112 such as target flash player version, size of file, information indicating whether the tags are compressed or not, among other such content. Tags, on the other hand, form the main component of the SWF file and describe the type of content stored in the SWF file including information about images, sounds, timeline, and the like that are used in the file. Certain tags can also be configured to contain ActionScript bytecode such as DolnitAction, DoAction, DefineButton, PlaceObject2, among others, wherein the bytecodes have the ability to jump between tags so that virtually any tag can contain executable code but only tags containing such bytecodes can be the entry points. Among different tags, DoABC and RawABC tags may be used to contain bytecodes and for accessing the code within SWF file. These tags can also be configured to include AS3 bytecode contained within a SWF, wherein DoABC tag, for instance, contains the .abc file, which maps to the .as file (ActionScript file) having the ActionScript code.

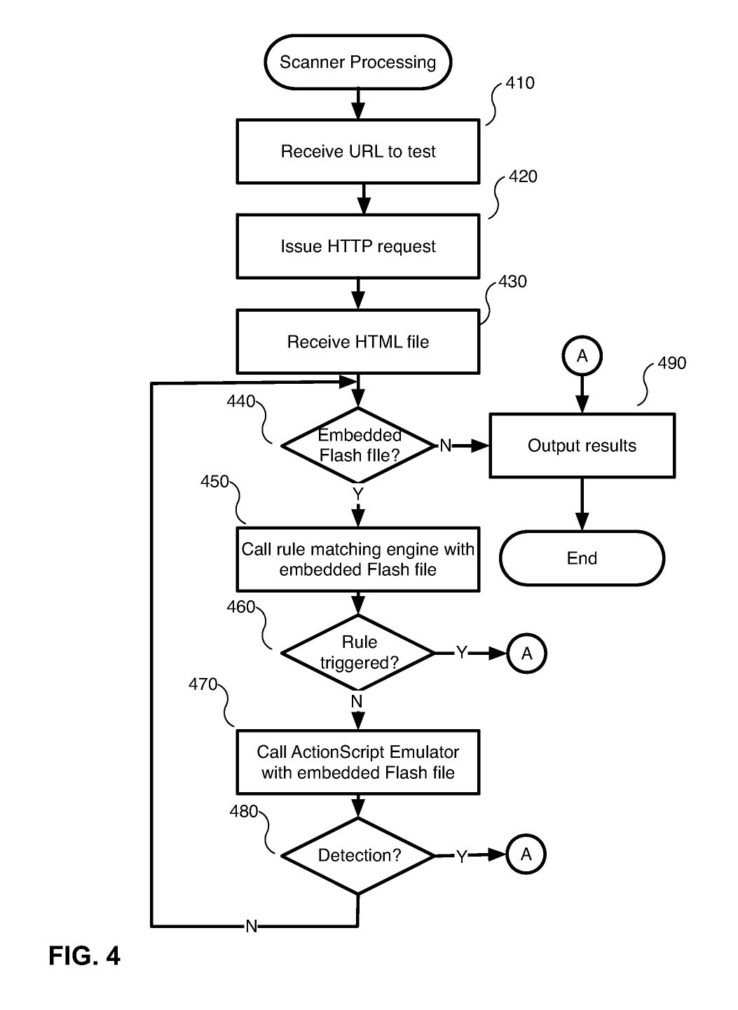

FIG. 4 is a flow diagram illustrating processing performed by a scanner in accordance with an embodiment of the present invention. Although various embodiments of the present invention are described with respect to an input to the scanner being a URL, it will be appreciated by those skilled in the art that other inputs may be used. For example, the input can include a file, containing a list of URLs or Flash files to be processed, a Flash file and the like. Depending upon the particular implementation, various process and decision blocks described in connection with this and other flow diagrams may be performed by hardware components, embodied in machine-executable instructions, which may be used to cause a general-purpose or special-purpose processor programmed with the instructions to perform the steps, or the steps may be performed by a combination of hardware, software and firmware.

At block 410, scanner receives an input Uniform Resource Locator (URL) that is to be tested for potential implementation of an exploiting technique or for any potential vulnerability or exploit. The scanner can be present, remote from the system/computing device from which input can be given or can be configured on the same system.

At block 420, based on the URL received as input, the scanner issues a HyperText Transport Protocol (HTTP) request for the URL. At block 430, in response to the HTTP request, the scanner receives a HyperText Markup Language (HTML) file and starts scanning the received HTML file to detect and extract one or more Flash files that are embedded in the HTML file.

At decision block 440, a determination is made regarding the existing of one or more embedded Flash files. If one or more Flash files are detected, then processing continues with block 450; otherwise, processing branches to block 490.

At block 450, a rule matching engine is called by the scanner with a Flash file to be processed. In one embodiment, the rule matching engine reads rules from a rule file and determines whether the Flash file matches any of the rules, which are defined based on known Flash exploits. According to one embodiment, the rule matching engine is a YARA scanner as described in Victor Manuel Alvarez, YARA A User's Manual, Version 1.6, which is hereby incorporated by reference in its entirety for all purposes. According to one embodiment, the rule matching engine is operatively coupled to the scanner and can either be implemented on the same computing device as the scanner or on a separate or remote device, which is connected to scanner over a network. Rule matching engine takes Flash file(s) as input and matches each Flash file with known or predefined set of signatures stored in the rule file. As numerous flash exploits are already well known, signatures for known flash exploits can be created such that the flash exploits can be detected without decoding the Flash files by simply matching input Flash files with signatures. In case Flash file matches a signature, rule matching engine can trigger the rule and present the respective exploit details as scan result to scanner. Using rule matching engine helps efficiently detect existence of known Flash exploits in Flash files.

Rule file can be operatively coupled with rule matching engine and can be stored in a database, wherein rule file stores specific signatures such as those corresponding to or otherwise identifying the existence of known Flash exploits, such as CVE-2012-0779, CVE-2012-1535 and the like. As these exploits are already known, their impact, behaviour, and manner of implementation is already known and therefore can be detected quickly. In case Flash files match with any of the signatures, the findings can be reported as a scan result to scanner. The scanner can then either choose to send the Flash files to the ActionScript emulator or present scan result to output. Flash files that are given as input to rule matching engine can also include embedded Flash files, which are embedded within Flash files extracted by scanner.

When multiple Flash files are referenced by or embedded within the HTML file, all the Flash files can either be given in parallel to the rule matching engine or can be given sequentially. In the present exemplary embodiment, it has been assumed that one Flash file is processed at a time. In case no Flash file is detected in the HTML file, an output indicating the same may be presented to output device. One such output can include mention of no detected flash exploits or exploiting techniques in the HTML file. Output can also present the time taken for scanning the HTML file, number of objects scanned, along with other attributes defining the HTML file.

At decision block 460, a determination is made regarding whether one or more rules of the rule matching engine were triggered. If so, then processing branches to block 490; otherwise processing continues with block 470.

At block 470, no Flash exploits corresponding to the rules stored in the rule file were detected by the rule matching engine. Therefore, processing of the Flash file continues by the scanner invoking the ActionScript emulator on the Flash file(s). According to one embodiment, the ActionScript emulator receives Flash file from scanner and is configured to, using one or more detectors implemented therein, to report to scanner if it detects conditions indicative of an exploit, an occurrence of heap spraying or JIT spraying, or existence of embedded Flash or embedded JavaScript. ActionScript emulator can be configured to implement one or more modified classes of classes typically implemented by an ActionScript Virtual Machine (AVM) and one or more modified operators of operators typically implemented by an AVM. ActionScript emulator therefore emulates the functionality of an AVM to provide a safe environment in which conditions indicative of heap spraying, JIT spraying, embedded Flash, embedded JavaScript and/or the existence of a known Flash exploit in Flash files, can be detected.

At decision block 480, a determination is made regarding whether a detection was made by the ActionScript emulator. According to one embodiment, a detection is triggered by one or more conditions indicative of heap spraying, JIT spraying, embedded Flash, embedded JavaScript and/or the existence of a known Flash exploit in Flash files. In one embodiment, when one or more exploiting techniques and/or embedded Flash/JavaScript are detected, the location of the exploit, they type of exploiting technique, and/or embedded Flash/JavaScript along with other desired information can be extracted by the ActionScript emulator and reported back to the scanner at block 490. If no detection was made by the ActionScript emulator (e.g.,), then processing continues with decision block 440 to identify the existence of other Flash files within the HTML file. Notably, in one embodiment, the ActionScript emulator may be recursively called by the scanner in the event that the ActionScript emulator identifies the existence of embedded Flash.

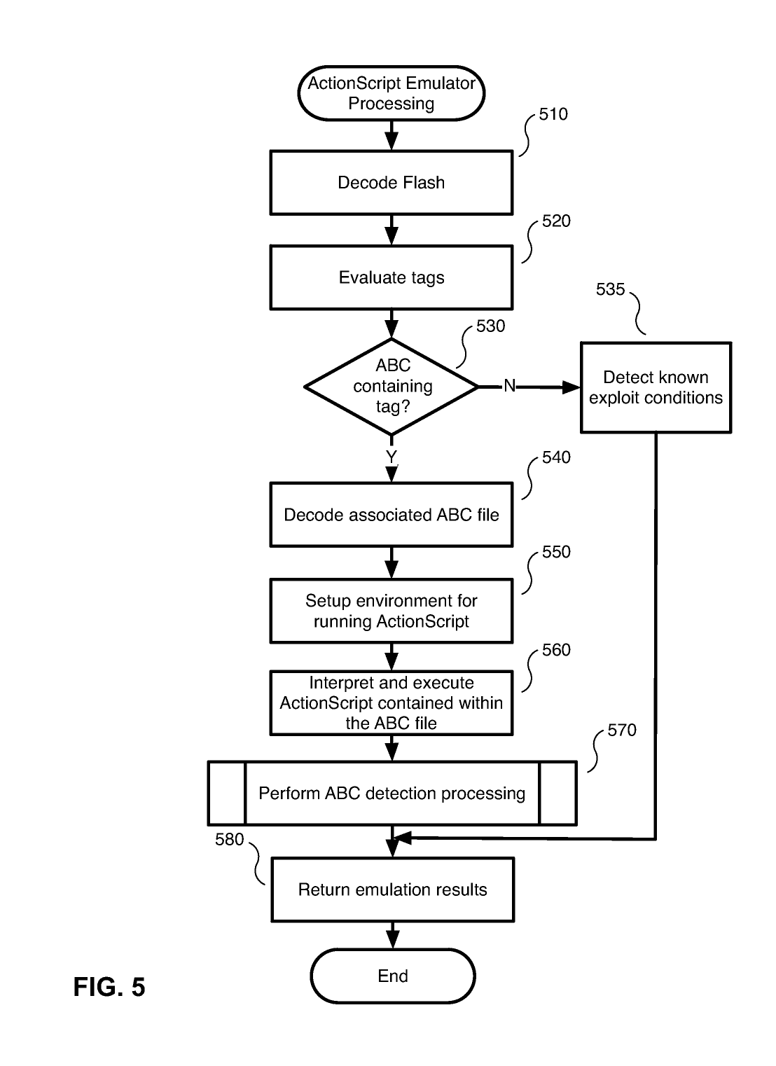

FIG. 5 is a flow diagram illustrating processing performed by an ActionScript emulator in accordance with an embodiment of the present invention. At block 510, the ActionScript emulator decodes a Flash file received from the scanner. The Flash file can be decoded based on the SWF file format specification. At block 520, ActionScript emulator evaluates tags of decoded Flash file to identify the occurrence of tags (e.g., a DoABC tag or a RawABC tag) that are capable of containing ActionScript bytecode (ABC).

At decision block 530, a determination is made regarding whether tags capable of containing ABC are present. If such tags are identified, then processing continues with block 540; otherwise, processing branches to block 535.

At block 535, no ABC containing tags were identified in decision block 530. However, not all known exploits rely upon embedded ABC. Therefore, according to one embodiment, an additional check is performed at block 535 to determine if the Flash file meets one or more conditions associated with known patterns used by known flash exploits. For example, in one embodiment, the ActionScript emulator may be used to detect exploit code present in a Flash file through one or more detectors incorporated in the code of ActionScript emulator positioned in classes, methods, objects, namespaces, or other code that form part of the sandbox environment created by ActionScript emulator. If the detector identifies within the Flash file the existence of one or more predetermined classes and/or protected namespaces of a class having a predetermined value, the ActionScript emulator may report the existence of a corresponding known exploit in the Flash file. One non-limiting example of a known Flash exploit that can be detected in this manner is the above-described CVE-2010-3654. When a known Flash exploit is identified, information related thereto can be extracted and sent to scanner as emulator result in block 580.

At block 540, the ABC file associated with a tag identified by decision block 530 is extracted and decoded based on the ABC file format specification.

At block 550, an environment is set up by ActionScript emulator for running ActionScript. The retrieved ABC is executed within a controlled sandbox-like environment provided by ActionScript emulator, wherein the environment implements, among other things, one or more modified classes of classes typically implemented by an ActionScript Virtual Machine (AVM) and/or one or more modified operators of operators typically implemented by an AVM. Detectors may be included within the ActionScript emulator and/or within the modified operators and/or methods of the modified classes that identify existence of one or more predetermined conditions associated with heap spraying, JIT spraying, an attempt to load embedded Flash and/or an attempt to evaluate embedded JavaScript by the ABC.

At block 560, ActionScript emulator interprets and executes the ActionScript contained within the ABC by parsing the ActionScript code and executing the parsed ActionScript code against the modified classes, methods and operators implemented by the ActionScript emulator. In this manner, the detectors positioned within the modified classes, methods and operators can determine whether the ABC exhibits conditions indicative of heap spraying, JIT spraying, an attempt to load embedded Flash and/or an attempt to evaluate embedded JavaScript by the ABC.

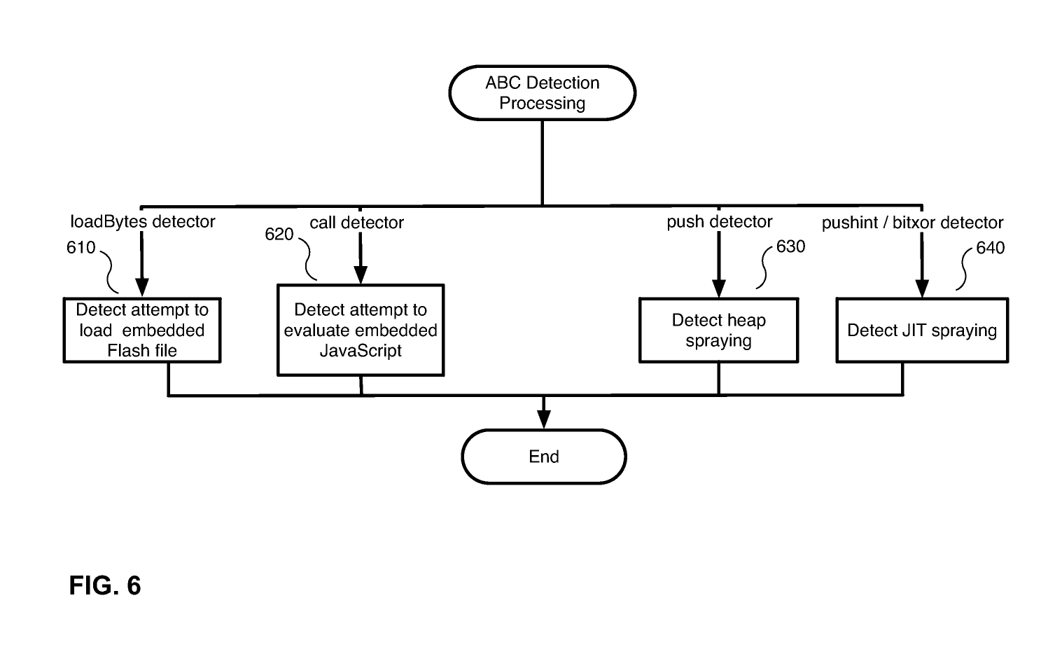

At block 570, detection processing is performed. According to one embodiment, detection processing involves detectors embedded within modified classes, methods and/or operators implemented by the ActionScript emulator evaluating one or more predetermined or configurable conditions to identify the existence of heap spraying, JIT spraying, an attempt to load embedded Flash and/or an attempt to evaluate embedded JavaScript by the ABC. According to one embodiment, the detection processing is as described with reference to the flow diagram of FIG. 6. In one embodiment, the ActionScript code is emulated within the ActionScript emulator to determine behaviour of the code corresponding to detectors and responsive to triggering of one or more of the detectors, the existence of the corresponding exploiting technique or occurrence of embedded Flash/JavaScript may be reported to the scanner. According to one embodiment, ActionScript emulator can also be configured to extract embedded Flash files and/or embedded JavaScript, if any, from the Flash file being processed so that the embedded code can be scanned and analyzed for a potential implementation of the exploit. If a rule can be created for a newly discovered exploit, then it can be added to the rule file of the rule matching engine to allow future detection via pattern matching.

At block 580, emulation results are returned to the scanner. For example, extracted Flash or extracted JavaScript can be returned to scanner along with other results relating to identification of one or more exploiting techniques. The results can be returned as emulator result and scanner can then, along with scan result from rule matching engine process final outcome and present the same on output device.

FIG. 6 is a flow diagram illustrating processing performed by ActionScript Emulator during detection of exploiting techniques or occurrence of embedded Flash/JavaScript in accordance with an embodiment of the present invention. In one embodiment, the detection processing described with reference to FIG. 6 is performed within block 570 of FIG. 5.

In the context of the present embodiment, ActionScript emulator is configured to process ABC that is contained in DoABC or RawABC tags of a Flash file and to identify whether conditions indicative of heap spraying, JIT spraying, embedded Flash or embedded JavaScript are met. The conditions can be implemented using one or more detectors implemented within the ActionScript emulator. According to one embodiment, detection processing is driven by the ABC. If the ABC makes calls to or otherwise invokes methods in which one or more detectors are present, then the detectors evaluate whether one or more predetermined or configurable conditions are met. Those skilled in the art will appreciate that the detectors described herein are non-limiting and that as other conditions indicative of conditions indicative of one or more of heap spraying, JIT spraying, embedded Flash and embedded JavaScript are discovered, the ActionScript emulator can be modified as appropriate to include appropriate additional detectors. Similarly, those skilled in the art will appreciate that some detection processing can be performed without emulating the ABC, by for example, analyzing the characteristics and/or content of the ABC.

At block 610, responsive to invocation of a loadBytes method by the ABC, a loadBytes detector implemented within the loadBytes method of a modified class Loader of the ActionScript emulator detects the presence of embedded Flash in the Flash file at issue. According to one embodiment, the detector is configured to implement a condition that detects an attempt to load embedded Flash. According to one embodiment, the modified loadBytes method is substantially as illustrated in Table H. In one embodiment, upon the condition being met, the embedded Flash is extracted and sent to the scanner for reporting to the end user and/or further analysis of the embedded Flash.

At block 620, responsive to invocation of a call method by the ABC, a call detector implemented within the ActionScript emulator detects an attempt to evaluate embedded JavaScript. According to one embodiment, the call detector is implemented within a call method of a modified class ExternalInterface provided by the ActionScript emulator. The call detector is configured to detect the existence of one or more conditions within the call method, which detect and identify whether embedded JavaScript is being evaluated. According to one embodiment, the call detector is triggered by the presence of the string “eval” as one of the parameters to the call method. According to one embodiment, the modified call method is substantially as illustrated in Table J. In one embodiment, upon the condition being met, the embedded JavaScript is extracted and sent to scanner for reporting to the end user and/or further analysis.

At block 630, responsive to invocation of a push method by the ABC, a push detector implemented within the ActionScript emulator detects behavior indicative of heap spraying in the form of attempts to push the same large size content to the same array multiple times. According to one embodiment, the push detector is implemented within a push method of a modified class Array provided by the ActionScript emulator. According to one embodiment, the push detector identifies potential heap spraying by the ABC of the Flash file by implement one or more conditions within the push method, which detect whether content of greater than a predetermined size is being pushed onto a particular array more than a predetermined number of times. According to one embodiment, the modified push method is substantially as illustrated in Table B. In one embodiment, upon the condition being met, potential heap spraying is detected and reported back to the scanner. Depending upon the particular implementation, the data attempted to be pushed onto the array can also be returned to the scanner for further analysis.

At block 640, responsive to invocation of a bitxor operator by the ABC, a pushint/bitxor detector implemented within the ActionScript emulator detects behavior indicative of JIT spraying in the form of successive pushint and bitxor operations exceeding a predetermined or configurable threshold. According to one embodiment, the pushint/bitxor detector is implemented within a modified bitxor operator provided by the ActionScript emulator. The pushint/bitxor detector is configured to detect the existence of one or more conditions within the bitxor operator that are indicative of potential JIT spraying. In one embodiment, the modified bitxor operator, detects whether successive pushint and bitxor operations exceed a predetermined threshold. According to one embodiment, the modified bitxor operator is substantially as illustrated in Table F. In one embodiment, upon the condition being met, potential JIT spraying is detected and reported back to the scanner. Depending upon the particular implementation, the data attempted to be pushed and xored can also be returned to the scanner for further analysis.

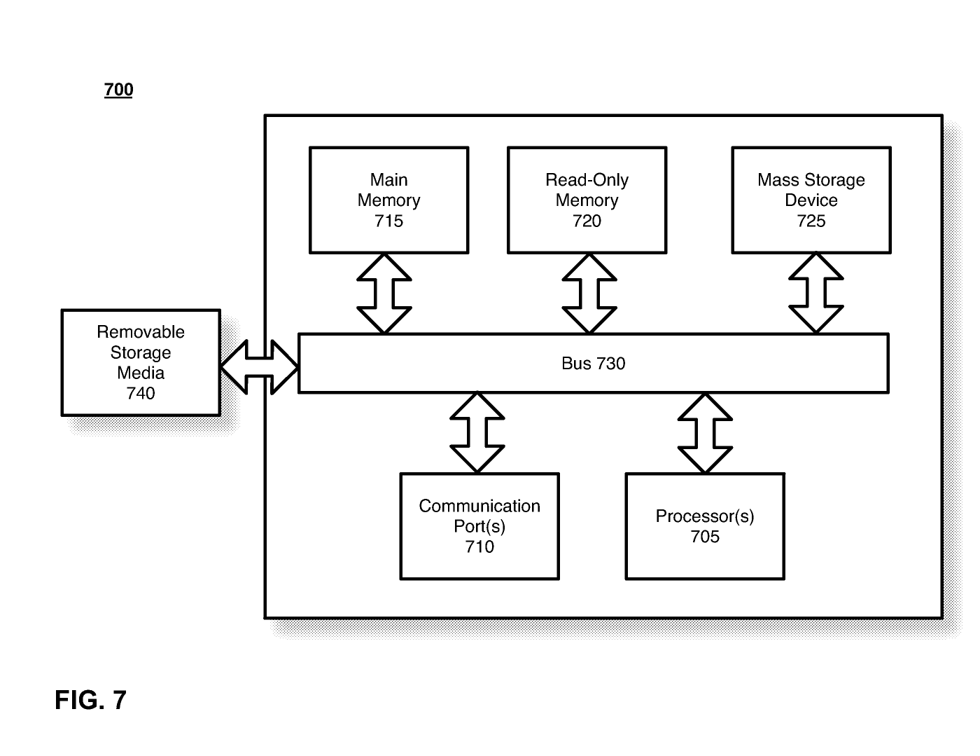

FIG. 7 is an example of a computer system 700 with which embodiments of the present disclosure may be utilized. Computer system 700 may represent or form a part of a scanner (e.g., scanner 110), rule matching engine (e.g., rule matching engine 120), ActionScript emulator (e.g., ActionScript emulator 130), a network gateway, a firewall, a network appliance, a server or a client workstation.

Embodiments of the present disclosure include various steps, which will be described in more detail below. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 700 includes a bus 730, a processor 705, communication port 710, a main memory 715, a removable storage media 740, a read only memory 720 and a mass storage 725. A person skilled in the art will appreciate that computer system 700 may include more than one processor and communication ports.

Examples of processor 705 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 705 may include various modules associated with monitoring unit as described in FIG. 2. Processor 705 may include resource communication module 220 for establishing communication with resources coupled to the network. Processor 705 may further include policy module 225 for including various policies and scoring schemes. In addition, processor 705 may include reputation module 230 for generating reputation of the resources coupled to the network.

Communication port 710 can be any of an RS-232 port for use with a modem based dialup connection, a 10/100 Ethernet port, a Gigabit or 10 Gigabit port using copper or fiber, a serial port, a parallel port, or other existing or future ports. Communication port 710 may be chosen depending on a network, such a Local Area Network (LAN), Wide Area Network (WAN), or any network to which computer system 700 connects.

Memory 715 can be Random Access Memory (RAM), or any other dynamic storage device commonly known in the art. Read only memory 720 can be any static storage device(s) such as, but not limited to, a Programmable Read Only Memory (PROM) chips for storing static information such as start-up or BIOS instructions for processor 705.

Mass storage 725 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 730 communicatively couples processor(s) 705 with the other memory, storage and communication blocks. Bus 730 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 705 to system memory.

Optionally, operator and administrative interfaces, such as a display, keyboard, and a cursor control device, may also be coupled to bus 730 to support direct operator interaction with computer system 700. Other operator and administrative interfaces can be provided through network connections connected through communication port 710.

Removable storage media 740 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

1. A method comprising:
receiving, by an ActionScript emulator running on a computer system, a Flash file to be tested, the ActionScript emulator implementing a modified version of a class implemented by an ActionScript virtual machine;
revealing, by the ActionScript emulator, one or more tagged data blocks (tags) contained within the Flash file by decoding the Flash file;
determining, by the ActionScript emulator, whether the one or more tags contain ActionScript bytecode (ABC) by evaluating the one or more tags;
when said determining results in an affirmative determination with respect to a tag of the one or more tags, then interpreting and executing, by the ActionScript emulator, the ABC associated with the tag; and
reporting existence of embedded Flash within the Flash file, by the ActionScript emulator, responsive to invocation of a predetermined method of the modified version of the class by the ABC.

2. The method of claim 1, wherein the modified version of the class comprises a class Loader having a loadBytes method and wherein the predetermined method comprises the loadBytes method.

3. The method of claim 1, wherein said determining comprises comparing the tag to a predetermined set of tags known to be capable of containing ABC.

4. The method of claim 3, wherein the predetermined set of tags includes a DoABC tag and a RawABC tag.

5. The method of claim 1, further comprising, prior to said receiving:
receiving, by a scanner running on the computer system, a uniform resource locator (URL) to be tested;
causing to be issued, by the scanner, a HyperText Transport Protocol (HTTP) request for the URL;
when a HyperText Markup Language (HTML) file is received responsive to the HTTP request, then determining, by the scanner, whether the HTML file contains an embedded Flash file; and
when said determining, by the scanner, whether the HTML file contains an embedded Flash file is affirmative, then causing the embedded Flash file to be checked against a predetermined set of signatures by invoking a rule matching engine on the embedded Flash file.

6. The method of claim 5, wherein the predetermined method implements a detector that reports and exports the embedded Flash to the scanner.

7. The method of claim 6, further comprising recursively calling, by the scanner, the ActionScript emulator with the embedded Flash.

8. A non-transitory computer-readable storage medium embodying a set of instructions implementing an ActionScript emulator, which when executed by one or more processors of one or more computer systems, cause the one or more processors to perform a method comprising:
receiving, by the ActionScript emulator, a Flash file to be tested, the ActionScript emulator implementing a modified version of a class implemented by an ActionScript virtual machine;
revealing, by the ActionScript emulator, one or more tagged data blocks (tags) contained within the Flash file by decoding the Flash file;
determining, by the ActionScript emulator, whether the one or more tags contain ActionScript bytecode (ABC) by evaluating the one or more tags;
when said determining results in an affirmative determination with respect to a tag of the one or more tags, then interpreting and executing, by the ActionScript emulator, the ABC associated with the tag; and
reporting existence of embedded Flash within the Flash file, by the ActionScript emulator, responsive to invocation of a predetermined method of the modified version of the class by the ABC.

9. The computer-readable storage medium of claim 8, wherein the modified version of the class comprises a class Loader having a loadBytes method and wherein the predetermined method comprises the loadBytes method.

10. The computer-readable storage medium of claim 8, wherein said determining comprises comparing the tag to a predetermined set of tags known to be capable of containing ABC.

11. The computer-readable storage medium of claim 10, wherein the predetermined set of tags includes a DoABC tag and a RawABC tag.

12. The computer-readable storage medium of claim 8, wherein the method further comprises, prior to said receiving:
receiving, by a scanner running on one or more of the computer systems, a uniform resource locator (URL) to be tested;
causing to be issued, by the scanner, a HyperText Transport Protocol (HTTP) request for the URL;
when a HyperText Markup Language (HTML) file is received responsive to the HTTP request, then determining, by the scanner, whether the HTML file contains an embedded Flash file; and
when said determining, by the scanner, whether the HTML file contains an embedded Flash file is affirmative, then causing the embedded Flash file to be checked against a predetermined set of signatures by invoking a rule matching engine on the embedded Flash file.

13. The computer-readable storage medium of claim 12, wherein the predetermined method implements a detector that reports and exports the embedded Flash to the scanner.

14. The computer-readable storage medium of claim 13, wherein the method further comprises recursively calling, by the scanner, the ActionScript emulator with the embedded Flash.

15. A computer system comprising:
a non-transitory storage device having embodied therein one or more routines implementing an ActionScript emulator; and
one or more processors coupled to the non-transitory storage device and operable to execute the one or more routines to perform a method comprising:
receiving, by the ActionScript emulator, a Flash file to be tested, the ActionScript emulator implementing a modified version of a class implemented by an ActionScript virtual machine;
revealing, by the ActionScript emulator, one or more tagged data blocks (tags) contained within the Flash file by decoding the Flash file;
determining, by the ActionScript emulator, whether the one or more tags contain ActionScript bytecode (ABC) by evaluating the one or more tags;
when said determining results in an affirmative determination with respect to a tag of the one or more tags, then interpreting and executing, by the ActionScript emulator, the ABC associated with the tag; and
reporting existence of embedded Flash within the Flash file, by the ActionScript emulator, responsive to invocation of a predetermined method of the modified version of the class by the ABC.

16. The computer system of claim 15, wherein the modified version of the class comprises a class Loader having a loadBytes method and wherein the predetermined method comprises the loadBytes method.

17. The computer system of claim 15, wherein said determining comprises comparing the tag to a predetermined set of tags known to be capable of containing ABC.

18. The computer system of claim 17, wherein the predetermined set of tags includes a DoABC tag and a RawABC tag.

19. The computer system of claim 15, wherein the method further comprises, prior to said receiving:
receiving, by a scanner running on the one or more processors, a uniform resource locator (URL) to be tested;
causing to be issued, by the scanner, a HyperText Transport Protocol (HTTP) request for the URL;
when a HyperText Markup Language (HTML) file is received responsive to the HTTP request, then determining, by the scanner, whether the HTML file contains an embedded Flash file; and
when said determining, by the scanner, whether the HTML file contains an embedded Flash file is affirmative, then causing the embedded Flash file to be checked against a predetermined set of signatures by invoking a rule matching engine on the embedded Flash file.

20. The computer system of claim 19, wherein the predetermined method implements a detector that reports and exports the embedded Flash to the scanner.

21. The computer system of claim 20, wherein the method further comprises recursively calling, by the scanner, the ActionScript emulator with the embedded Flash.
